(19) United States
(12) Patent Application Publication
(10) Pub. No.: US 2013/0030908 A1
(43) Pub. Date: Jan. 31, 2013

(54) Conversion Path Comparison Reporting

(71) Applicants: Jason S. Gessner, Milwaukee, WI (US); Matthias Blume, Chicago, IL (US); Jacob Matthews, Chicago, IL (US); Daniel Benson, Evanston, IL (US)

(72) Inventors: Jason S. Gessner, Milwaukee, WI (US); Matthias Blume, Chicago, IL (US); Jacob Matthews, Chicago, IL (US); Daniel Benson, Evanston, IL (US)

(73) Assignee: Google Inc.

(21) Appl. No.: 13/192,814

(22) Filed: Jul. 28, 2011

(51) Int. Cl. G06Q 30/00

(52) U.S. Cl. 705/14.45

(57) ABSTRACT

Methods, systems, and apparatuses, including computer programs encoded on computer-readable media, for obtaining information regarding a plurality of conversion paths that each end with a conversion interaction, wherein each conversion path includes one or more user interactions that include a plurality of dimensional data related to the user interaction. For each conversion path, it is determined if the conversion path includes a particular user interaction, a first position of the particular user interaction, and the number of user interactions of the conversion path. The conversion paths are grouped based upon if the conversion path includes the particular user interaction. For each conversion path group, an average position of the particular user interaction and an average path length based upon the path length of the conversion paths is computed. Data regarding the average position of the particular user interaction and the average path length is provided.

### BACKGROUND

The Internet provides access to a wide variety of content. For instance, images, audio, video, and web pages for a myriad of different topics are accessible through the Internet. The accessible content provides an opportunity to place advertisements. Advertisements can be placed within content, such as a web page, image or video, or the content can trigger the display of one or more advertisements, such as presenting an advertisement in an advertisement slot.

Advertisers decide which ads are displayed within particular content using various advertising management tools. These tools also allow an advertiser to track the performance of various ads or ad campaigns. The parameters used to determine when to display a particular ad can also be changed using advertising management tools.

The data that is used to generate the performance measures for the advertiser generally includes all data that is available. This data usually includes a combination of data from multiple servers. The amount of the combined data is large enough that performance measures generated from the data can be used to provide an efficient way of understanding the data. Processing of the data to generate useful and accurate performance measures involves a number of obstacles. For instance, if a performance measure is based upon a user's actions over a period of time, the user's actions should be tracked. A cookie can be used to track a user's actions over a period of time. However, if this cookie is removed during the period of time, collection of accurate data tracking the user's actions may be disrupted. The data can contain record user actions that include various actions that are significant to an advertiser. These actions, which can be any recordable event, are called conversions. Identifying other actions that contribute to the occurrence of conversions is valuable. The data, however, contains numerous actions that could be associated with conversions. In addition, the data may also contain information regarding user actions that do not contribute to any recorded conversions. Thus, processing the data to provide accurate and reliable performance measures based upon all the available information regarding user actions has a number of challenges.

### SUMMARY

In general, one innovative aspect of the subject matter described in this specification can be embodied in methods that include obtaining information regarding a plurality of conversion paths, wherein each conversion path includes one or more user interactions, wherein a user interaction includes a plurality of dimensional data that are related to the user interaction, wherein each conversion path corresponds to a single user, and wherein each conversion path ends with a conversion interaction. For each conversion path, it is determined if the conversion path includes a particular user interaction, a first position of the particular user interaction in the conversion path, and the number of the one or more user interactions of the conversion path. The conversion paths are grouped based upon the determination if the conversion path includes the particular user interaction. For each conversion path group, an average position of the particular user interaction based upon the first position of the particular user interaction in the conversion paths and an average path length based upon the path length of the conversion paths is computed. Data regarding the average position of the particular user interaction and the average path length is provided. Other embodiments of this aspect include corresponding apparatuses, computing devices configured to execute instructions that perform the methods, and systems.

### BRIEF DESCRIPTION OF THE DRAWINGS

The details of one or more embodiments of the subject matter described in this specification are set forth in the accompanying drawings and the description below. Other features, aspects, and advantages of the subject matter will become apparent from the description, the drawings, and the claims.

FIG. 1 is a block diagram of an example environment in which an advertisement management system manages advertising services in accordance with an illustrative embodiment.

FIG. 2 is a flow diagram of a process for integrating user interaction log data in accordance with an illustrative embodiment.

FIG. 3 is a block diagram that illustrates user interaction data being updated during a user interaction log data integration process in accordance with an illustrative embodiment.

FIG. 4 is a flow diagram of a process for determining data associated with conversion paths in accordance with an illustrative embodiment.

FIG. 5 is an illustrative report regarding a particular conversion type with data grouped at a network level in accordance with an illustrative embodiment.

FIG. 6 is an illustrative report regarding a particular conversion type with data grouped at a site level in accordance with an illustrative embodiment.

FIG. 7 is an illustrative report regarding all conversion types with data grouped at a network level in accordance with an illustrative embodiment.

FIG. 8 is an illustrative report regarding a particular conversion type comparing two different user interactions with data grouped at a network level in accordance with an illustrative embodiment.

FIG. 9 is an illustrative report regarding all conversion types comparing two different placements of a user interaction with data grouped at a network level in accordance with an illustrative embodiment.

FIG. 10 is a block diagram of a computer system in accordance with an illustrative embodiment.

Like reference numbers and designations in the various drawings indicate like elements.

### DETAILED DESCRIPTION

Content providers (e.g., advertisers) are provided various reports that disclose various user interactions with content. Each user interaction can include a number of dimensions, which can contain data associated with the user interaction. An advertiser can select one or more user interactions to signify a conversion. Reports can be generated that illustrate the various user interactions that lead up to conversions. These reports can be used by an advertiser to analyze the performance of a particular ad or campaign. For instance, by comparing conversions paths that include displaying a particular advertisement across multiple websites, an advertiser can gain insight into the performance of the particular advertisement. In addition, other reports can be generated that compare various conversion paths with other conversion paths that can help an advertiser determine the performance advertisements and campaigns.

As used throughout this document, user interactions include any presentation of content to a user and any subsequent affirmative actions or non-actions (collectively referred to as “actions” unless otherwise specified) that a user takes in response to presentation of content to the user (e.g., selections of the content following presentation of the content, or no selections of the content following the presentation of the content). Thus, a user interaction does not necessarily require a selection of the content (or any other affirmative action) by the user.

User interaction measures can include one or more of time lag measures (i.e., measures of time from one or more specified user interactions to a conversion), path length measures (i.e., quantities of user interactions that occurred prior to conversions), user interaction paths (i.e., sequences of user interactions that occurred prior to the conversion), assist interaction measures (i.e., quantities of particular user interactions that occurred prior to the conversion), and assisted conversion measures (i.e., quantities of conversions that were assisted by specified content).

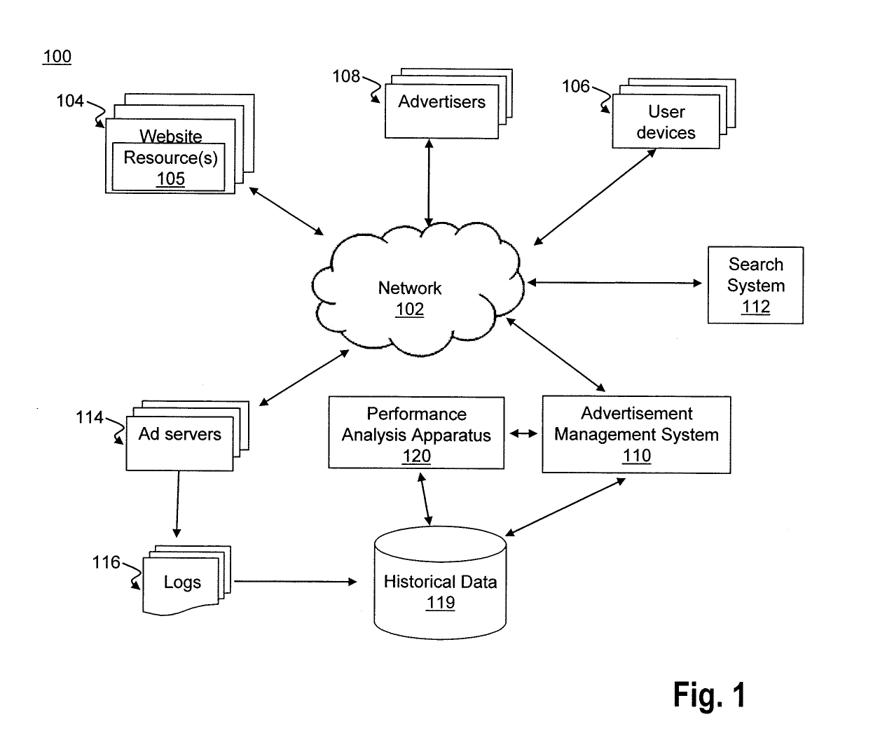

FIG. 1 is a block diagram of an example environment in which an advertisement management system manages advertising services in accordance with an illustrative embodiment. The example environment 100 includes a network 102, such as a local area network (LAN), a wide area network (WAN), the Internet, or a combination thereof. The network 102 connects websites 104, user devices 106, advertisers 108, and an advertisement management system 110. The example environment 100 may include many thousands of websites 104, user devices 106, and advertisers 108.

A website 104 includes one or more resources 105 associated with a domain name and hosted by one or more servers. An example website is a collection of web pages formatted in hypertext markup language (HTML) that can contain text, images, multimedia content, and programming elements, such as scripts.

A resource 105 is any data that can be provided over the network 102. A resource 105 is identified by a resource address that is associated with the resource 105, such as a uniform resource locator (URL). Resources 105 can include web pages, word processing documents, portable document format (PDF) documents, images, video, programming elements, interactive content, and feed sources, to name only a few. The resources 105 can include content, such as words, phrases, images and sounds, that may include embedded information (such as meta-information in hyperlinks) and/or embedded instructions. Embedded instructions can include code that is executed at a user's device, such as in a web browser. Code can be written in languages such as JavaScript® or ECMAScript®.

A user device 106 is an electronic device that is under control of a user and is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can include data specifying a portion of the resource or a portion of a user display (e.g., a presentation location of a pop-up window or in a slot of a web page) in which advertisements can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources 105 provided on the websites 104. Data about the resources 105 can be indexed based on the resource 105 with which the data is associated. The indexed and, optionally, cached copies of the resources 105 are stored in a search index (not shown).

User devices 106 can submit search queries to the search system 112 over the network 102. In response, the search system 112 accesses the search index to identify resources 105 that are relevant to the search query. In one illustrative embodiment, a search query includes one or more keywords. The search system 112 identifies the resources 105 that are responsive to the query, provides information about the resources 105 in the form of search results and returns the search results to the user devices 106 in search results pages. A search result can include data generated by the search system 112 that identifies a resource 105 that is responsive to a particular search query, and can include a link to the resource 105. An example search result can include a web page title, a snippet of text or a portion of an image extracted from the web page 104, a rendering of the resource 105, and the URL of the web page 104. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifier can be anonymized and is not connected with user names. Because HTTP is a stateless protocol, the use of cookies allows an external service, such as the search system 112 or other system, to track particular actions and status of a user over multiple sessions. A user may opt out of tracking user actions, for example, by disabling cookies in the browser's settings.

When a resource 105 or search results are requested by a user device 106 or provided to the user device 106, the advertisement management system 110 receives a request for advertisements to be provided with the resource 105 or search results. The request for advertisements can include characteristics of the advertisement slots that are defined for the requested resource 105 or search results page, and can be provided to the advertisement management system 110. For example, a reference (e.g., URL) to the resource 105 for which the advertisement slot is defined, a size of the advertisement slot, and/or media types that are available for presentation in the advertisement slot can be provided to the advertisement management system 110. Similarly, keywords (i.e., one or more words that are associated with content) associated with a requested resource 105 (“resource keywords”) or a search query for which search results are requested can also be provided to the advertisement management system 110 to facilitate identification of advertisements that are relevant to the resource 105 or search query.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries. In some implementations, advertisements having targeting keywords that match the resource keywords, the search query, or portions of the search query are selected as eligible advertisements by the advertisement management system 110.

The advertisement management system 110 selects an eligible advertisement for each advertisement slot of a resource 105 or of a search results page. The resource 105 or search results page is received by the user device 106 for presentation by the user device 106. User interaction data representing user interactions with presented advertisements can be stored in a historical data store 119. For example, when an advertisement is presented to the user via an ad server 114, data can be stored in a log file 116. This log file 116, as more fully described below, can be aggregated with other data in the historical data store 119. Accordingly, the historical data store 119 contains data representing the advertisement impression. For example, the presentation of an advertisement is stored in response to a request for the advertisement that is presented. For example, the ad request can include data identifying a particular cookie, such that data identifying the cookie can be stored in association with data that identifies the advertisement(s) that were presented in response to the request. In some implementations, the data can be stored directly to the historical data store 119.

Similarly, when a user selects (i.e., clicks) a presented advertisement, data representing the selection of the advertisement can be stored in the log file 116, a cookie, or the historical data store 119. In some implementations, the data is stored in response to a request for a web page that is linked to by the advertisement. For example, the user selection of the advertisement can initiate a request for presentation of a web page that is provided by (or for) the advertiser. The request can include data identifying the particular cookie for the user device, and this data can be stored in the advertisement data store.

User interaction data can be associated with unique identifiers that represent a corresponding user device with which the user interactions were performed. For example, in some implementations, user interaction data can be associated with one or more cookies. Each cookie can include content which specifies an initialization time that indicates a time at which the cookie was initially set on the particular user device 106.

The log files 116, or the historical data store 119, also store references to advertisements and data representing conditions under which each advertisement was selected for presentation to a user. For example, the historical data store 119 can store targeting keywords, bids, and other criteria with which eligible advertisements are selected for presentation. Additionally, the historical data store 119 can include data that specifies a number of impressions for each advertisement and the number of impressions for each advertisement can be tracked, for example, using the keywords that caused the advertisement impressions and/or the cookies that are associated with the impressions. Data for each impression can also be stored so that each impression and user selection can be associated with (i.e., stored with references to and/or indexed according to) the advertisement that was selected and/or the targeting keyword that caused the advertisement to be selected for presentation.

The advertisers 108 can submit, to the advertisement management system 110, campaign parameters (e.g., targeting keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements. The campaign performance report can also provide a total cost, a cost-per-click, and other cost measures for the advertisement over a specified period of time. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword hockey can be attributed with 1,000 impressions, 20 clicks, and 5 conversions.

As described above, reports that are provided to a particular content provider can specify performance measures measuring user interactions with content that occur prior to a conversion. A conversion occurs when a user performs a specified action, and a conversion path includes a conversion and a set of user interactions occurring prior to the conversion by the user. Any user interaction or user interactions can be deemed a conversion. What constitutes a conversion may vary from case to case and can be determined in a variety of ways. For example, a conversion may occur when a user clicks on an advertisement, is referred to a web page or website, and then consummates a purchase there before leaving the web page or website. As another example, a conversion may occur when a user spends more than a given amount of time on a particular website. Data from multiple user interactions can be used to determine the amount of time at the particular website.

Actions that constitute a conversion can be specified by each advertiser. For example, each advertiser can select, as a conversion, one or more measurable/observable user actions such as, for example, downloading a white paper, navigating to at least a given depth of a website, viewing at least a certain number of web pages, spending at least a predetermined amount of time on a website or web page, or registering on a website. Other actions that constitute a conversion can also be used.

To track conversions (and other interactions with an advertiser's website), an advertiser can include, in the advertiser's web pages, embedded instructions that monitor user interactions (e.g., page selections, content item selections, and other interactions) with advertiser's website, and can detect a user interaction (or series of user interactions) that constitutes a conversion. In some implementations, when a user accesses a web page, or another resource, from a referring web page (or other resource), the referring web page (or other resource) for that interaction can be identified, for example, by execution of a snippet of code that is referenced by the web page that is being accessed and/or based on a URL that is used to access the web page.

For example, a user can access an advertiser's website by selecting a link presented on a web page, for example, as part of a promotional offer by an affiliate of the advertiser. This link can be associated with a URL that includes data (i.e., text) that uniquely identifies the resource from which the user is navigating. For example, the link http://www.example.com/homepage/%affiliate_identifier%promotion_{—}1 specifies that the user navigated to the example.com web page from a web page of the affiliate that is associated with the affiliate identifier number that is specified in the URL, and that the user was directed to the example.com web page based on a selection of the link that is included in the promotional offer that is associated with promotion_{—}1. The user interaction data for this interaction (i.e., the selection of the link) can be stored in a database and used, as described below, to facilitate performance reporting.

When a conversion is detected for an advertiser, conversion data representing the conversion can be transmitted to a data processing apparatus (“analytics apparatus”) that receives the conversion data, and in turn, stores the conversion data in a data store. This conversion data can be stored in association with one or more cookies for the user device that was used to perform the user interaction, such that user interaction data associated with the cookies can be associated with the conversion and used to generate a performance report for the conversion.

Typically, a conversion is attributed to a targeting keyword when an advertisement that is targeted using the targeted keyword is the last clicked advertisement prior to the conversion. For example, advertiser X may associate the keywords “tennis,” “shoes,” and “Brand-X” with advertisements. In this example, assume that a user submits a first search query for “tennis,” the user is presented a search result page that includes advertiser X's advertisement, and the user selects the advertisement, but the user does not take an action that constitutes a conversion. Assume further that the user subsequently submits a second search query for “Brand-X,” is presented with the advertiser X's advertisement, the user selects advertiser X's advertisement, and the user takes action that constitutes a conversion (e.g., the user purchases Brand-X tennis shoes). In this example, the keyword “Brand-X” will be credited with the conversion because the last advertisement selected prior to the conversion (“last selected advertisement”) was an advertisement that was presented in response to the “Brand-X” being matched.

Providing conversion credit to the keyword that caused presentation of the last selected advertisement (“last selection credit”) prior to a conversion is a useful measure of advertisement performance, but this measure alone does not provide advertisers with data that facilitates analysis of a conversion cycle that includes user exposure to, and/or selection of, advertisements prior to the last selected advertisement. For example, last selection credit measures alone do not specify keywords that may have increased brand or product awareness through presentation of advertisements that were presented to, and/or selected by, users prior to selection of the last selected advertisement. However, these advertisements may have contributed significantly to the user subsequently taking action that constituted a conversion.

In the example above, the keyword “tennis” is not provided any credit for the conversion, even though the advertisement that was presented in response to a search query matching the keyword “tennis” may have contributed to the user taking an action that constituted a conversion (e.g., making a purchase of Brand-X tennis shoes). For instance, upon user selection of the advertisement that was presented in response to the keyword “tennis” being matched, the user may have viewed Brand-X tennis shoes that were available from advertiser X. Based on the user's exposure to the Brand-X tennis shoes, the user may have subsequently submitted the search query “Brand-X” to find the tennis shoes from Brand-X. Similarly, the user's exposure to the advertisement that was targeted using the keyword “tennis,” irrespective of the user's selection of the advertisement, may have also contributed to the user subsequently taking action that constituted a conversion (e.g., purchasing a product from advertiser X). Analysis of user interactions, with an advertiser's advertisements (or other content), that occur prior to selection of the last selected advertisement can enhance an advertiser's ability to understand the advertiser's conversion cycle.

A conversion cycle is a period that begins when a user is presented an advertisement and ends at a time at which the user takes action that constitutes a conversion. A conversion cycle can be measured and/or constrained by time or actions and can span multiple user sessions. User sessions are sets of user interactions that are grouped together for analysis. Each user session includes data representing user interactions that were performed by a particular user and within a session window (i.e., a specified period). The session window can be, for example, a specified period of time (e.g., 1 hour, 1 day, or 1 month) or can be delineated using specified actions. For example, a user search session can include user search queries and subsequent actions that occur over a 1 hour period and/or occur prior to a session ending event (e.g., closing of a search browser).

Analysis of a conversion cycle can enhance an advertiser's ability to understand how its customers interact with advertisements over a conversion cycle. For example, if an advertiser determines that, on average, an amount of time from a user's first exposure to an advertisement to a conversion is 20 days, the advertiser can use this data to infer an amount of time that users spend researching alternative sources prior to converting (i.e., taking actions that constitute a conversion). Similarly, if an advertiser determines that many of the users that convert do so after presentation of advertisements that are targeted using a particular keyword, the advertiser may want to increase the amount of money that it spends on advertisements distributed using that keyword and/or increase the quality of advertisements that are targeted using that particular keyword.

Measures of user interactions that facilitate analysis of a conversion cycle are referred to as conversion path performance measures. A conversion path is a set of user interactions by a particular user prior to and including a conversion by the particular user. Conversion path performance measures specify durations of conversion cycles, numbers of user interactions that occurred during conversion cycles, paths of user interactions that preceded a conversion, numbers of particular user interactions that occurred preceding conversions, as well as other measures of user interaction that occurred during conversion cycles, as described in more detail below.

The advertisement management system 110 includes a performance analysis apparatus 120 that determines conversion path performance measures that specify measures of user interactions with content items during conversion cycles. The performance analysis apparatus 120 tracks, for each advertiser, user interactions with advertisements that are provided by the advertiser, determines (i.e., computes) one or more conversion path performance measures, and provides data that cause presentation of a performance report specifying at least one of the conversion path performance measures. Using the performance report, the advertiser can analyze its conversion cycle, and learn how each of its keywords cause presentation of advertisements that facilitate conversions, irrespective of whether the keywords caused presentation of the last selected advertisement. In turn, the advertiser can adjust campaign parameters that control distribution of its advertisements based on the performance report.

Configuration options can be offered to reduce bias in performance reports. Without configuration options, some performance reports can be biased, such as towards short conversion paths. For example, a performance report can be biased towards short conversion paths if data used as a basis for the report includes a percentage of partial conversion paths which is higher than a threshold percentage. A partial conversion path is a conversion path in which some but not all user interaction data for a user is associated with a conversion. A partial conversion path can be included in a report if, for example, the report is generated using a reporting period which is less then the length of a typical conversion cycle for the advertiser who requested the report.

A reporting period determines the maximum length (in days) of a reported conversion cycle because additional data outside of the reporting period is not used to generate the report. A performance report can be based on a reporting period (i.e., lookback window), such that user interactions prior to the reporting period are not considered part of the conversion cycle when generating the report. Such a reporting period is referred to as a “lookback window”. For example, when generating a report with a lookback window of thirty days, available user interaction data representing user actions that occurred between July 1 and July 31 of a given year would be available for a conversion that occurred on July 31 of that year.

If a default lookback window (e.g., thirty days) is used, the performance report can be biased towards short conversion paths if the typical conversion cycle length for a product associated with the report is greater than the default lookback window. For instance, in the example above, a typical conversion cycle for “Brand-X” tennis shoes may be relatively short (e.g., thirty days) as compared to a conversion cycle for a more expensive product, such as a new car. A new car may have a much longer conversion cycle (e.g., ninety days).

Different advertisers or different products for an advertiser can have different associated conversion cycle lengths. For example, an advertiser that sells low cost (e.g., less than $100) products may specify a lookback window of 30 days, while an advertiser that sells more expensive products (e.g., at least $1000) may specify a lookback window of 90 days.

In some implementations, an advertiser 108 can specify a lookback window to use when requesting a performance report, such as by entering a number of days or by selecting a lookback window from a list of specific lookback windows (e.g., thirty days, sixty days, ninety days). Allowing an advertiser to configure the lookback window of their performance reports enables the advertiser to choose a lookback window that corresponds to conversion cycles of their products. Allowing lookback window configuration also enables advertisers to experiment with different lookback windows, which can result in the discovery of ways to improve conversion rates.

Other factors can contribute to reporting on partial conversion paths. For example, as mentioned above, user interaction data used as a basis for a report can be associated with unique identifiers that represent a user device with which the user interactions were performed. As described above, a unique identifier can be stored as a cookie. Cookies can be deleted from user devices, such as by a user deleting cookies, a browser deleting cookies (e.g., upon browser exit, based on a browser preference setting), or some other software (e.g., anti-spyware software) deleting cookies.

If cookies are deleted from a user device, a new cookie will be set on the user's device when the user visits a web page (e.g., the search system 112). The new cookie may be used to store a new quasi-unique identifier, and thus subsequent user interaction data that occurs on the user device may be associated with a different identifier. Therefore, because each user identifier is considered to represent a different user, the user interaction data associated with the deleted cookies are identified as being associated with a different user than the user interaction data that is associated with the new cookies.

For instance, in the example above, assume that the user deletes cookies after the first search query for “tennis” is performed and that the second search query for “Brand-X” occurs after the cookies are deleted. In this example, performance measures computed based on the user interaction data for the user can show a bias. For example, a path length measure can be computed as one, rather than two, since the advertisement selection resulting from the first search query is not considered part of the same conversion cycle as the advertisement selection resulting from the second search query, since the two user interactions do not appear to have been performed by the same user.

To view a report which reduces bias caused from partial conversion paths, an advertiser can specify a lookback window for the report. As described above, the lookback window specifies that the user interaction data used to generate the report are user interaction data that are associated with unique identifiers that have initialization times that are prior to a specified period (e.g., thirty days, sixty days, ninety days) before the conversions. Thus, conversions for which user interaction data that are associated with unique identifiers having initialization times that are after the specified period are excluded from inclusion as a basis for the report. A unique identifier that has a recent initialization time indicates that the unique identifier may have been recently reinitialized on the user device that the unique identifier represents. Accordingly, user interaction data associated with the relatively new unique identifier may represent only a partial conversion path. Alternatively, conversions for which user interaction data that are associated with unique identifiers having initialization times that are after the specified period are included in the report. To reduce bias, any user interaction included in the conversion path that occurred after the specified period are removed from the conversion path prior to being included in the report.

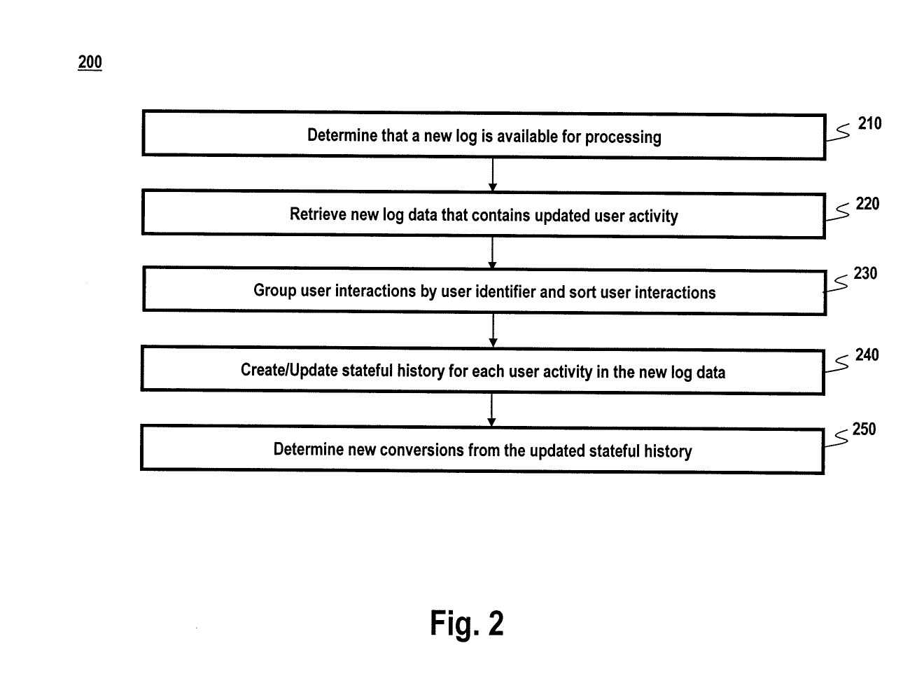

FIG. 2 is a flow diagram of a process for integrating user interaction log data in accordance with an illustrative embodiment. The process 200 is a process that updates conversion paths and determines conversions based upon the updated conversion paths of users.

The process 200 can be implemented on the advertisement management system 110, the performance analysis apparatus 120, or another computing device. In one implementation, the process 200 is encoded on a computer-readable medium that contains instructions that when executed by a computing device cause the computing device to perform operations of process 200.

As described above, log files 116 may contain user interaction data. A log file 116 may be combined with user interaction data from other logs from other servers, including those that implement the search system 112, prior to processing. Processing starts with the computing device that implements the process 200 determining that a new log is available for processing (210). For example, a notification can be sent to the computing device indicating that a new log is ready for processing, or the existence of a new log can indicate that the new log is ready for processing.

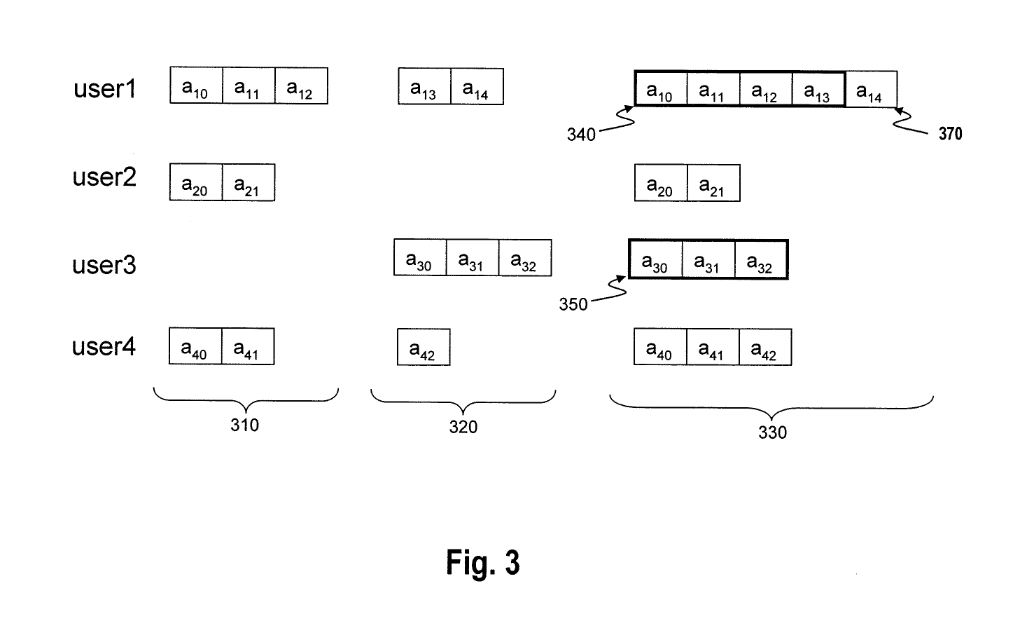

Next, the new log is retrieved (220). The new log may be retrieved over the network 102. The stateful history for each user is updated based upon the user activity indicated by the new log. The new log can contain information relating to user interactions for numerous users. The historical data store 119 contains user interaction data from previously processed log files. The user interaction data contained within the historical data store 119 can be stateful, in that the user interaction data can be grouped by user identifier and ordered chronologically. FIG. 3 is a block diagram that illustrates user interaction data being updated during a user interaction log data integration process 200 in accordance with an illustrative embodiment. FIG. 3 illustrates four example user identifiers, although the historical data store 119 and log files 116 can contain data associated with thousands or millions of different user identifiers. In one embodiment, previously stored user interaction data 310 are stored in the historical data store 119. As illustrated, no user interaction data associated with user identifier 3 has been previously stored in the historical data store 119.

The new log can contain user interaction data for one or more user identifiers. The user interaction data can be grouped by user identifiers and then sorted chronologically (230). Column 320 illustrates grouped and sorted user interaction data. As illustrated, user identifier 2 does not include any new user interaction data, and user identifiers 1, 3, and 4 have updated user interaction data. For instance, the new log file includes user interaction data associated with user interactions a₁₃ and a₁₄ that are associated with user identifier 1. The grouped and sorted user interaction data can then merged with the user interaction data stored in the historical data store 119 (240). If a user identifier previously existed in the historical data store 119, the new user interaction data are added to the previous user interaction data. Otherwise, the new user interaction data is added with a new user identifier.

Column 330 illustrates the updated user interaction data for each of the user identifiers. Based upon the updated user interaction data, any conversions that occurred in each of the updated paths of user interactions can be determined (250). User interaction paths are constrained to those user interactions that are related to a particular advertiser 108. The conversion interactions of the particular advertiser 108 are used to determine if a conversion has occurred. As an example, assume that user interactions a₁₃ and a₃₂ represent conversion interactions. Accordingly, conversion paths 340 and 350 are found. Once found, the conversion paths can be written to another portion of the historical data store 119 or another data store for further analysis.

In one embodiment, a conversion indicates the end of a conversion path. The conversion path 340 associated with user1 is one example. User interaction 370 is associated with user1, but occurred after the conversion user interaction a₁₃. A new unconverted path that includes user interaction a₁₄ 370 is associated with user1. There are, therefore, two paths associated with user1, the converted path 340 and the unconverted path. In an alternative embodiment, a conversion path includes all past user interactions, including past conversions. Returning to user1 of FIG. 3, the conversion path 340 is still associated with user1. The unconverted path includes not only user interaction a₁₄ 370 but also all of the user interactions from the conversion path 340. In this embodiment, a past conversion can be determined to have assisted in the later conversion.

Each user interaction includes a set of data or dimensions associated with the user interaction. The dimensions can be sparsely populated, such that, any user interaction may have data relating to a subset of the dimensions. Dimensions can include a source, a medium, and a referring source of a user interaction. The medium dimension can indicate the type of user interaction and the source can indicate where a user interaction originated. Dimensions can also include a campaign and keywords that are associated with a user interaction. A large number of conversion paths can be generated based upon received user interaction data. Various reports regarding how a campaign or an advertiser's placements are performing can include various information regarding the conversion paths. Performance can be determined or inferred by comparing various groups of conversion paths.

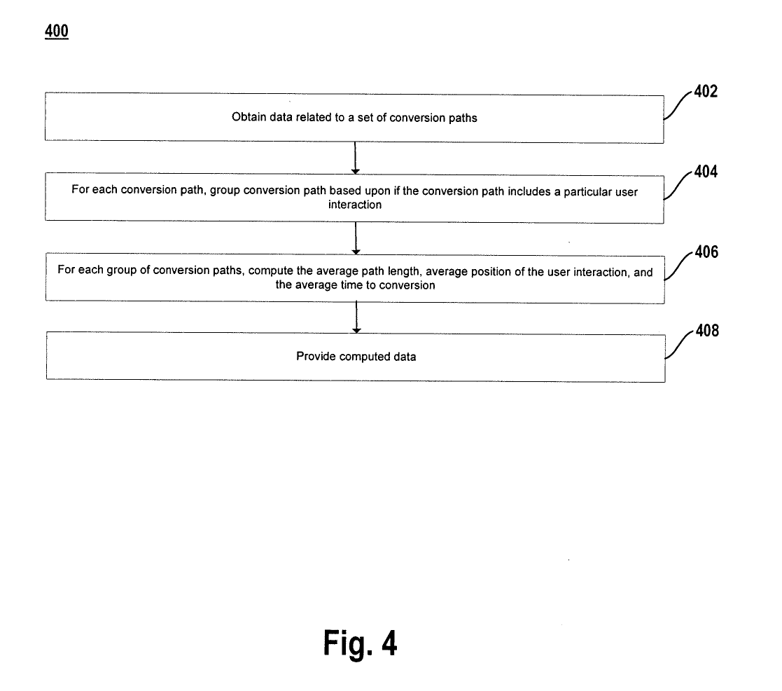

FIG. 4 is a flow diagram of a process 400 for determining data associated with conversion paths in accordance with an illustrative embodiment. The process 400 begins by obtaining data related to a set of conversion paths (402). In one embodiment, all conversion paths for a particular advertiser are obtained. An advertiser may have a large number of conversions. Filtering some of the conversions allows more targeted reports to be generated. In another embodiment, all conversions and corresponding conversion paths that are associated with a particular conversion are obtained. In yet another embodiment, only conversion paths that include a user interaction that originated from a particular website are obtained. Conversion paths that are associated with a particular advertising campaign can also be obtained.

The user interactions included in a conversion path can vary. Conversion paths can include all of the user interactions that occurred through the conversion. In another embodiment, the conversion paths include user interactions that occurred within a specified time preceding the conversion. For example, the identified user interactions may include the user interactions that occurred within 30 days preceding the conversion, but exclude user interactions that occurred prior to the 30 days preceding the conversion. A set number of days is not required. In another embodiment, the number of days can be dynamically set based upon the conversion path data. For example, the number of days can be set such that a certain number of conversion paths, e.g. 67%, 75%, 90%, etc., occur within the number of days. In yet another embodiment, conversion paths that include user interactions that all occurred within a time period are excluded. Such filtering allows conversion paths that may be incomplete, for example because a cookie was removed, to be excluded from the report. These filtering mechanism can also be combined. For example, conversion paths with less than 1 day of user interaction data can be filtered along with user interactions that occurred 30 days prior to the conversion.

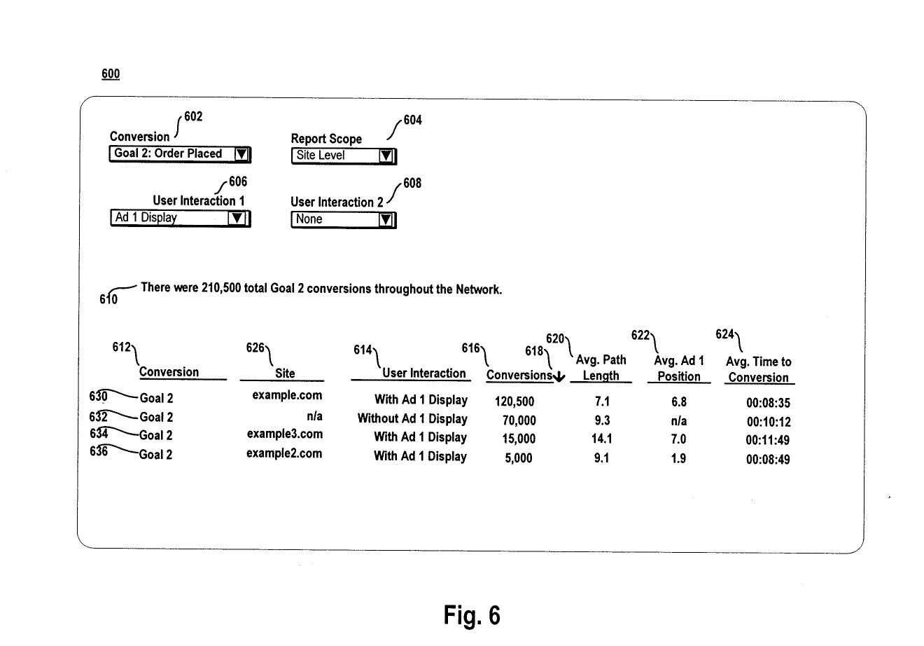

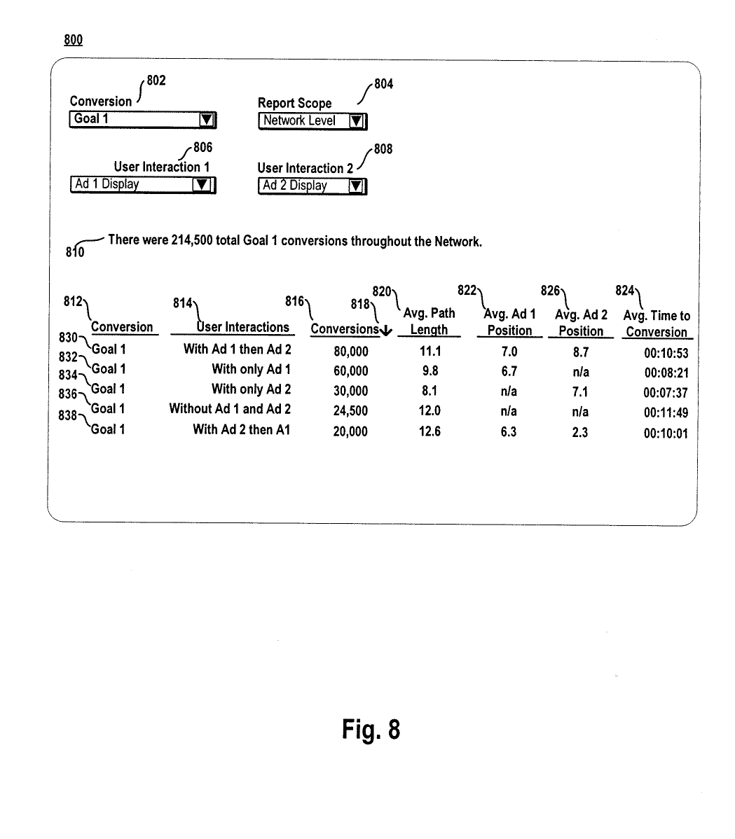

Once obtained, the conversion paths are grouped (404). Conversion paths are grouped based upon the scope and selected user interactions. In one embodiment, for each conversion type, the conversion paths are grouped based upon the presence of a particular user interaction within the conversion path. In another embodiment, the site that originated a user interaction can be used to group conversion paths. FIG. 6, described in greater detail below, is one illustrative example. In another embodiment, the conversion paths are grouped based upon if the conversion path includes one or more user interactions. When conversion paths are grouped based upon two or more user interactions, the order of the user interactions can be important. An example of grouping conversion paths based upon the order in which user interactions occur is described in greater detail below in regard to FIG. 8

Once the groups are determined, data relating to the groups can be calculated (406). Dimensional data associated with the user interactions of the conversion paths can be used to derive data. Computed data for each group can include the number of conversions in each group, the average path length of each group, the position of each selected user interaction within the conversion path, and the average time to conversion. Other data values can be calculated such as the a maximum path length, a minimum path length, a median path length, median time to conversion, maximum time to conversion, minimum time to conversion, value of the conversion, time to each selected user interaction, and other statistical measures (e.g., standard deviation) can be computed.

After the data is computed, the data can be provided to a user or a data store (408). Providing the data can include displaying various data in various graphics or charts such as a histogram, pie chart, bar chart, etc. The data can also be provided in a text form. In addition, providing the data can include providing instructions that displays the data.

The process 400 is described with reference to advertising campaigns that control distribution of advertisements in an online environment. However, the process 400 can also be used with other content distribution campaigns that control distribution of other content (e.g., video, audio, games, or other content). The process 400 can be implemented, for example, by the performance analysis apparatus 120 of FIG. 1. In some implementations, the performance analysis apparatus 120 is a data processing apparatus that includes one or more processors that are configured to perform actions of the process 400. In other implementations, a computer readable medium can include instructions that, when executed by a computer, cause the computer to perform actions of the process 400.

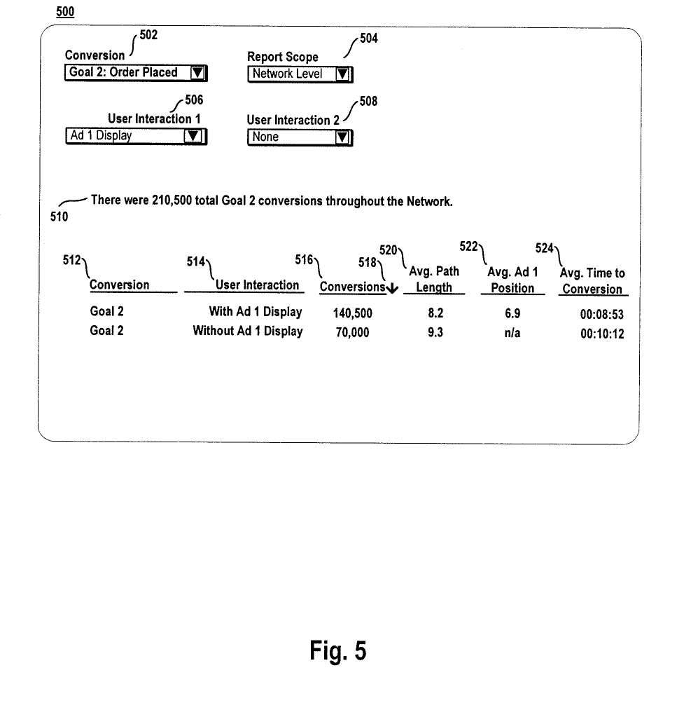

FIG. 5 is an illustrative report regarding a particular conversion type with data grouped at a network level in accordance with an exemplary embodiment. Report 500 illustrates one possible way of selecting the conversion, scope, and user interactions that are used to generate the computed data. A user can select a particular conversion using a drop down box 502. The drop down box 502 can be populated with every conversion associated with a particular advertiser. An All Conversions option can also be included that allows a report to be generated for every type of conversion. The scope of the report can be selected using another drop down box 504. Possible settings for the scope of the report can include a network level, a site level, or a campaign level. In another embodiment, the types of conversions to include in a report can be selected using a custom filtering component. For example, only conversions that occurred within a particular time frame can be selected. The user interactions of the conversion paths can also be used to filter the conversions that are included in any report. A user can include conversion paths that include one or more particular user interactions or types of user interactions. Alternatively, conversion paths can be excluded based upon these criteria.

A first user interaction can be selected using a drop down box 506 and a second, optional user interaction can be selected using a drop down box 508. The drop down boxes 506 and 508 can be populated with all distinct user interactions related to an advertiser. The drop down boxes 506 and 508 can also be populated with a subset of the user interactions. For example, user interactions relating to a particular advertisement, a particular keyword, or generated from a particulate site may be used to populate the available options of drop down boxes 506 and 508. In the report 500, an “Ad 1 Display” user interaction is selected that corresponds to displaying an “Ad 1” advertisement to a user. Similar to selecting the conversion paths to include in a report, the particular user interaction can be selected using selection criteria instead of selecting one particular user interaction. For example, a user interaction can be any advertisement that was displayed on a particular site. Selecting user interactions that correspond to a keyword search of a search engine that includes a provided keyword is another example.

Once variables are selected, data relating to the conversion paths can be retrieved. The report 500 is based upon conversion paths corresponding to a “Goal 2” conversion throughout the network. A summary 510 of the returned conversion paths can be provided. In one embodiment, the summary 510 can include the total number of conversions that are included in the report. The conversion paths are grouped into groups based upon the report scope and the selected user interaction. In the report 500, the conversion paths are grouped into two groups: those that include an “Ad 1 Display” user interaction and those that do not. Columns 512 and 514 provide an overview of how the conversion paths were grouped.

Once the conversion paths are grouped, various data relating to the grouped conversion paths can be calculated. Column 516 indicates the number of conversions in each group. Indicator 518 indicates that the data is sorted in descending order based upon the number of conversions in each group. The data can be sorted by any other column and can be sorted either in descending or ascending order. In one embodiment, the names of each column can be selected to indicate the column to use to sort the data. Column 520 indicates the average path length for the conversion paths in each group, and column 522 indicates the average position of the “Ad 1 Display” user interactions within the conversion paths. For groups of conversion paths that do not include an “Ad 1 Display” user interaction, no average position of the “Ad 1 Display” user interaction exists. Column 524 indicates the average time to the conversion for conversions in each group.

Data from these columns can be compared by a user or by the system to determine the effectiveness of displaying advertisement “Ad 1” to users. For instance, in report 500 the average path length and average time to conversion for conversion paths that include an “Ad 1 Display” user interaction are shorter than conversion paths that do not include an “Ad 1 Display” user interaction. Such data can indicate that displaying the “Ad 1” advertisement to users is effective at generating Goal 2 conversions.

Report 500 grouped the conversion paths based solely on whether the conversion path included an “Ad 1 Display” user interaction. The “Ad 1” advertisement may be displayed on a number of websites. As each website may attract different users, the “Ad 1” advertisement may be more effective on one website compared to another website. FIG. 6 is an illustrative report regarding a particular conversion type with data grouped at a site level in accordance with an illustrative embodiment. Report 600 provides a report similar to report 500. The scope of the report, however, is different. “Site Level” is the scope of report 600, and causes the conversion paths to be grouped based upon both the “Ad 1 Display” user interaction and the site that displayed the “Ad 1” advertisement. Accordingly, column 626 contains the sites that correspond with the various conversion path groups.

Rows 630, 634, and 636 correspond to conversion paths that include a user interaction that corresponds to displaying advertisement “Ad 1”. Each row corresponds to a different site that displayed the “Ad 1” advertisement. Row 632 corresponds to conversion paths that do not include displaying an “Ad 1” advertisement. This row contains the same data as the corresponding row from FIG. 5. Report 600 provides further data relating to the effectiveness of the “Ad 1” advertisement. Comparing rows 630 and 632, conversions happen quicker and have a shorter path length when advertisement “Ad 1” is displayed on an example.com website. Comparing data in row 630 with data from report 500 provides an indication that advertisement “Ad 1” is effective on the example.com website.

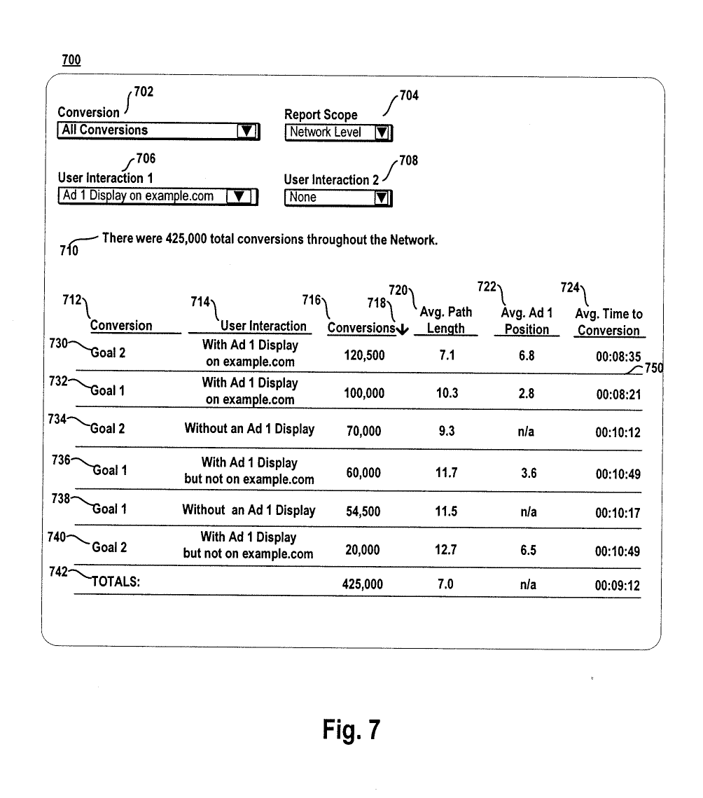

Reports 500 and 600 provide information concerning a particular conversion, “Goal 2: Order Placed.” An advertiser can have multiple conversion types, and the reports can include data from multiple types of conversions. FIG. 7 is an illustrative report regarding all conversion types with data grouped at a network level in accordance with an illustrative embodiment. Report 700 includes data regarding all of an advertiser's conversion based upon the selection of the drop down box 702. Data corresponding with “Goal 2” conversions corresponds to data from the report 600. Row 730 corresponds with row 630 of report 600, row 734 corresponds with row 632 of report 600, and row 740 corresponds to rows 634 and 636 of report 600. Rows 732, 736, and 738 provide information regarding conversions of type “Goal 1.” Accordingly, an advertiser can compare different conversion paths of different conversions. Two conversion types are illustrated in report 700, however, advertisers can have any number of conversion types.

In addition to including all conversion types, the conversion paths are grouped based upon the user interaction selected in drop down box 706. In report 700, conversion paths are grouped based upon if a particular conversion path includes a user interaction corresponding to displaying the “Ad 1” advertisement on the website example.com. This feature allows an advertiser to compare how an advertisement displayed on a particular website impacts conversions. The rows 730 and 732 correspond to conversion paths that include at least one user interaction regarding displaying advertisement “Ad 1” on example.com. Report 700 allows an advertiser to compare how the “Ad 1” advertisement impacts conversions compared to conversion paths that include displaying the “Ad 1” advertisement on another website or conversion paths that do not include displaying the Ad. Comparing the rows 730 and 732 with rows 734, 736, 738, and 740 indicate that conversion paths on average are shorter when the “Ad 1” advertisement is displayed on example.com. In addition, the average time to a conversion is shorter. Report 700 also allows the comparison of displaying the “Ad 1” advertisement on example.com with displaying the “Ad 1” advertisement on other sites. Row 730 compared with row 734 indicates that displaying the “Ad 1” advertisement on example.com has a positive impact on conversions. This indication is the same as derived from the comparison of rows 630 and 632 of report 600. The information provided in reports 600 and 700 may indicate that increasing the number of “Ad 1” advertisements on example.com may increase the number of conversions of type “Goal 2.”

Report 700 also indicates how the “Ad 1” advertisement impacts conversions of types “Goal 1” and “Goal 2.” For both conversion types, the “Ad 1” advertisement appears to have a positive impact on conversions. Where on average the “Ad 1” advertisement is displayed in the conversion path, however, is different. For example, the row 730 and column 722 indicates that the average position of displaying the “Ad 1” advertisement is 6.8. The average conversion path length, as indicated in the row 730 and column 720, is 7.1. The “Ad 1” advertisement, therefore, is displayed near the end of the conversion path for “Goal 2” conversions. “Goal 1” conversions, however, show a different impact. The average “Ad 1” advertisement position is 2.8 and the average conversion path length is 6.6. For “Goal 1” conversions, therefore, the “Ad 1” advertisement is displayed on average near the beginning of the conversion path. Such comparisons can be used to determine where to display a particular ad within an advertising network.

Different types of conversions can refer to different interactions with content. For example, one type of conversion can be associated with the purchase of a particular product and a second type of conversion can be associated with the purchase of a different product. Advertisements can be created with the intention of influencing one or more particular types of conversions. An advertisement is considered to be on-target if the advertisement has a positive influence on the one or more intended types of conversions. The advertisement may also influence other unintended conversion types. For these conversions, the advertisement would be considered to be off-target. Report 700 can be used to determine if a particular advertisement is on-target. If the “Ad 1” advertisement was created with the intention of positively influencing “Goal 2” type conversions, row 730 is an indication that the “Ad 1” advertisement is on-target. Row 732 also indicates that the “Ad 1” advertisement has a positive impact on “Goal 1” type conversions. In regard to “Goal 1” type conversions, the “Ad 1” advertisement is off-target. Even though the “Ad 1” advertisement can be considered off-target for “Goal 1” type conversions, this information can be useful in understanding how users convert for both “Goal 1” and “Goal 2” type conversions.

As the amount of data in a report increases, row separators, such as 750, can be used to visually separate rows. In another embodiment, a background color of each row can be changed or the background colors can alternate to visually separate the rows. Report 700 also includes a total row 742 that provides data regarding all of the conversions included in the report 700. The other illustrated reports can also include similar row separators and/or a total row.

In addition to comparing an advertisement across various sites, a user interaction can be compared with another user interaction. FIG. 8 is an illustrative report regarding a particular conversion type comparing two different user interactions with data grouped at a network level in accordance with an illustrative embodiment. Report 800 includes data regarding how the “Ad 1” advertisement and an “Ad 2” advertisement impact conversion paths of type “Goal 1.” A drop down box 808 can be used to select the second user interaction. Because a second user interaction is included in the report 800, column 826 indicates the average position of the second user interaction in the conversion paths.

Report 800 allows a comparison between the two selected user interactions. Rows 830 and 832 compared with row 836 indicate that displaying the “Ad 1” advertisement has a positive influence on conversions. In addition, comparing rows 832 and 834 with row 836 indicates that displaying the “Ad 2” advertisement also has a positive impact on conversions. Row 838, however, indicates that displaying the “Ad 2” advertisement before the “Ad 1” advertisement may negatively impact conversions. An advertiser, accordingly, may provide instructions that the “Ad 1” advertisement is to be displayed prior to the “Ad 2” advertisement. Based upon these instructions, the advertisement management system 110 can ensure that the “Ad 1” advertisement is displayed prior to the “Ad 2” advertisement. In addition, if the “Ad 2” advertisement has been displayed to a user, the advertisement management system 110 can ensure that the “Ad 1” advertisement will not be selected and displayed to the user.

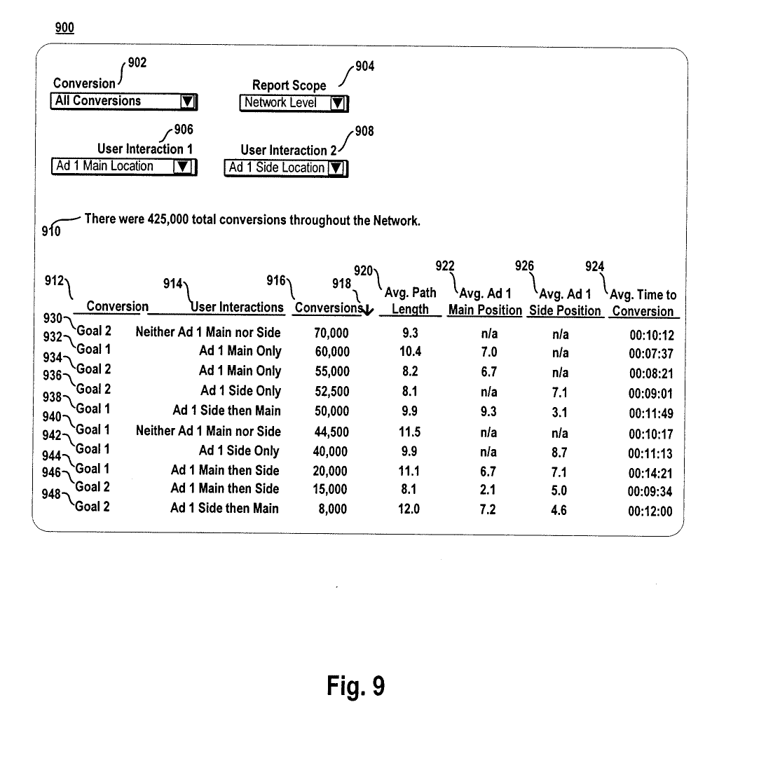

Advertisements can be displayed in various locations a webpage. The placement of the advertisement may impact the effectiveness of the advertisement. FIG. 9 is an illustrative report regarding all conversion types comparing two different placements of a user interaction with data grouped at a network level in accordance with an illustrative embodiment. Report 900 compares the placement of the “Ad 1” advertisement in a main location versus a side location. The advertisement may be displayed on many different websites. The layout and design of these websites can vary radically. The advertisement, therefore, is likely to be displayed in numerous different locations throughout the websites. Various locations can be grouped together when selecting a particular user interaction. For example, the main location of report 900 may correspond to displaying the advertisement in the top third, top quarter, top most position, etc., of any webpage. Similarly, the side location may correspond to displaying the advertisement on the left hand portion, right hand portion, the left or right hand portion, etc., of any webpage. Once selected, conversion paths related to displaying the selected user interaction in the selected placements can be compared.

Rows 932, 938, 942, and 944 compared with row 940 indicate that displaying the “Ad 1” advertisement in either the main location or the side location lowers the average conversion path length of “Goal 1” type conversions. In addition, rows 938 and 942 may indicate that displaying the “Ad 1” advertisement later in a conversion path in the side location positively impacts conversions. Accordingly, an advertiser may provide instructions to increase the number of “Ad 1” advertisements in the side location, especially, for users with longer conversion path lengths. Based upon these instructions the advertisement management system 110 can select the “Ad 1” advertisement in the side location for users with longer conversion paths. Displaying the “Ad 1” advertisement in the main or side location also appears to have a positive impact on conversions of “Goal 2” type. Comparing rows 934 and 936 with row 930 indicates that displaying the “Ad 1” advertisement reduces the average path length and the average conversion time.

Using report 900, the other illustrated reports, and similar reports that can be generated advertisers can gain an insight into how various advertisements, search results from search engines, email advertisements, social media, and other various user interactions impact conversions. With this data, advertisers can adjust parameters of advertising campaigns. For instance, advertisers may increase or decrease the display of a particular advertisement, may increase or decrease the sites that display an advertisement, etc. The advertisement management system 100 can use these parameters in selecting an advertisement for a particular user.

The advertisement management system 110 and/or the performance analysis apparatus 120 can be realized by instructions that upon execution cause one or more processing devices to carry out the processes and functions described above. Such instructions can comprise, for example, interpreted instructions, such as script instructions, executable code, or other instructions stored in a computer-readable medium. The advertisement management system 110 and/or the performance analysis apparatus 120 can be distributively implemented over a network, such as a server farm, or can be implemented in a single computer device.

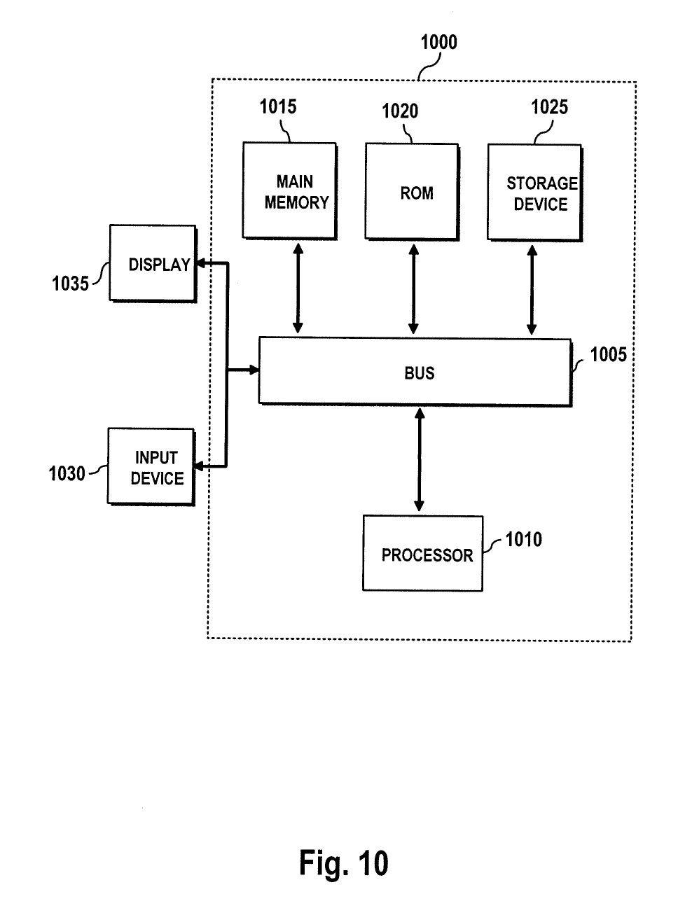

FIG. 10 illustrates a depiction of a computer system 1000 that can be used to provide user interaction reports, process log files, implement an illustrative performance analysis apparatus 120, or implement an illustrative advertisement management system 110. The computing system 1000 includes a bus 1005 or other communication component for communicating information and a processor 1010 coupled to the bus 1005 for processing information. The computing system 1000 also includes main memory 1015, such as a random access memory (RAM) or other dynamic storage device, coupled to the bus 1005 for storing information, and instructions to be executed by the processor 1010. Main memory 1015 can also be used for storing position information, temporary variables, or other intermediate information during execution of instructions by the processor 1010. The computing system 1000 may further include a read only memory (ROM) 1010 or other static storage device coupled to the bus 1005 for storing static information and instructions for the processor 1010. A storage device 1025, such as a solid state device, magnetic disk or optical disk, is coupled to the bus 1005 for persistently storing information and instructions.

The computing system 1000 may be coupled via the bus 1005 to a display 1035, such as a liquid crystal display, or active matrix display, for displaying information to a user. An input device 1030, such as a keyboard including alphanumeric and other keys, may be coupled to the bus 1005 for communicating information, and command selections to the processor 1010. In another embodiment, the input device 1030 has a touch screen display 1035. The input device 1030 can include a cursor control, such as a mouse, a trackball, or cursor direction keys, for communicating direction information and command selections to the processor 1010 and for controlling cursor movement on the display 1035.

According to various embodiments, the processes that effectuate illustrative embodiments that are described herein can be implemented by the computing system 1000 in response to the processor 1010 executing an arrangement of instructions contained in main memory 1015. Such instructions can be read into main memory 1015 from another computer-readable medium, such as the storage device 1025. Execution of the arrangement of instructions contained in main memory 1015 causes the computing system 1000 to perform the illustrative processes described herein. One or more processors in a multi-processing arrangement may also be employed to execute the instructions contained in main memory 1015. In alternative embodiments, hard-wired circuitry may be used in place of or in combination with software instructions to implement illustrative embodiments. Thus, embodiments are not limited to any specific combination of hardware circuitry and software.

Although an example processing system has been described in FIG. 10, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
obtaining information regarding a plurality of conversion paths, wherein each conversion path comprises one or more user interactions, wherein a user interaction comprises a plurality of dimensional data that are related to the user interaction, wherein each conversion path corresponds to a single user, and wherein each conversion path ends with a conversion interaction;
for each conversion path:
determining if the conversion path includes a particular user interaction;
determining a first statistical value based upon the user interactions in the conversion path; and
determining a second statistical value based upon the user interactions in the conversion path;
grouping the conversion paths based upon the determination if the conversion path includes the particular user interaction;
for each conversion path group:
computing, using a processor, an average first statistical value based upon the first statistical value; and
computing, using a processor, an average second statistical value based upon the second statistical value; and
providing data regarding the average first statistical value and the second statistical value.

2. The method of claim 1, further comprising:
for each conversion path:
determining a first user interaction of the conversion path;
determining a last user interaction of the conversion path, wherein the last user interaction is the conversion interaction;
determining a time to conversion based upon the difference between a time of the last user interaction and a time of the first user interaction; and
for each conversion path group:
computing, using a processor, an average time to conversion based upon the time to conversion of the conversion paths; and
providing data regarding the average time to conversion.

3. The method of claim 1, wherein grouping the conversion paths further comprises grouping the conversion paths based upon a website associated with the particular user interaction.

4. The method of claim 1, further comprising:
determining if the particular user interaction is associated with a particular website, wherein grouping the conversion paths further comprises grouping the conversion paths based upon the determination if the particular user interaction is associated with the particular website.

5. The method of claim 1, wherein grouping the conversion paths further comprises grouping the conversion paths based upon a determination if the conversion path includes a second particular user interaction.

6. The method of claim 5, further comprising:
for each conversion path:
determining if the conversion path includes the second particular user interaction;
determining a second position of the second particular user interaction in the conversion path;
for each conversion path group:
computing, using a processor, a second average position of the second particular user interaction based upon the second position of the second particular user interaction in the conversion paths
providing data regarding the second average position.

7. The method of claim 1, wherein grouping the conversion paths further comprises grouping the conversion paths based upon a location of the particular user interaction.

8. The method of claim 7, further comprising:
for each conversion path:
determining a second position of the particular user interaction in the conversion path, wherein the second position relates to a second location of the particular user interaction, wherein the first particular user interaction relates to the particular user interaction in a first location;
for each conversion path group:
computing, using a processor, a second average position of the particular user interaction based upon the second position of the particular user interaction in the conversion paths; and
providing data regarding the second average position.

9. The method of claim 1, wherein one or more conversion paths comprise two or more conversion interactions.

10. An apparatus comprising:
a data store configured to store information regarding a plurality of conversion paths, wherein each conversion path comprises one or more user interactions, wherein a user interaction comprises a plurality of dimensional data that are related to the user interaction, wherein each conversion path corresponds to a single user, and wherein each conversion path ends with a conversion interaction; and
a computing device operably coupled to memory configured to:
obtain the information regarding a plurality of conversion paths;
for each conversion path:
determine if the conversion path includes a particular user interaction;
determine a first statistical value based upon the user interactions in the conversion path;
determine a second statistical value based upon the user interactions in the conversion path;
group the conversion paths based upon the determination if the conversion path includes the particular user interaction;
for each conversion path group:
compute an average first statistical value based upon the first statistical value; and
compute an average second statistical value based upon the second statistical value; and
provide data regarding the average first statistical value and the second statistical value.

11. The apparatus of claim 10, wherein the computing device is further configured to:
for each conversion path:
determine a first user interaction of the conversion path;
determine a last user interaction of the conversion path, wherein the last user interaction is the conversion interaction;
determine a time to conversion based upon the difference between a time of the last user interaction and a time of the first user interaction; and
for each conversion path group:
compute an average time to conversion based upon the time to conversion of the conversion paths; and
provide data regarding the average time to conversion.

12. The apparatus of claim 10, wherein the computing device is further configured to group the conversion paths by also grouping the conversion paths based upon a website associated with the particular user interaction.

13. The apparatus of claim 10, wherein the computing device is further configured to:
determine if the particular user interaction is associated with a particular website, wherein grouping the conversion paths further comprises grouping the conversion paths based upon the determination if the particular user interaction is associated with the particular website.

14. The apparatus of claim 10, wherein the computing device is configured to group the conversion paths by also grouping the conversion paths based upon the determination if the conversion path includes a second particular user interaction.

15. The apparatus of claim 10, wherein the processor is further configured to group the conversion paths by also grouping the conversion paths based upon a location of the particular user interaction.

16. The apparatus of claim 10, wherein one or more conversion paths comprise two or more conversion interactions.

17. A tangible computer-readable medium having instructions stored thereon that, if executed by a computing device, cause the computing device to perform operations comprising:
obtaining information regarding a plurality of conversion paths, wherein each conversion path comprises one or more user interactions, wherein a user interaction comprises a plurality of dimensional data that are related to the user interaction, wherein each conversion path corresponds to a single user, and wherein each conversion path ends with a conversion interaction;
for each conversion path:
determining if the conversion path includes a particular user interaction;
determining a first statistical value based upon the user interactions in the conversion path;
determining a second statistical value based upon the user interactions in the conversion path;
grouping the conversion paths based upon the determination if the conversion path includes the particular user interaction;
for each conversion path group:
computing an average first statistical value based upon the first statistical value; and
computing an average second statistical value based upon the second statistical value; and
providing data regarding the average first statistical value and the second statistical value.

18. The tangible computer-readable medium of claim 17, wherein grouping the conversion paths further comprises grouping the conversion paths based upon the determination if the conversion path includes a second particular user interaction.

19. The tangible computer-readable medium of claim 17, wherein grouping the conversion paths further comprises grouping the conversion paths based upon a location of the particular user interaction.

20. The tangible computer-readable medium of claim 17, wherein one or more conversion paths comprise two or more conversion interactions.
